(19) United States
(12) Patent Application Publication
(10) Pub. No.: US 2018/0312419 A1
(43) Pub. Date: Nov. 1, 2018

(54) WATER REUSE SYSTEMS AND RELATED METHODS AND APPARATUSES

(71) Applicant: AquaFresco, Inc., Somerville, MA (US)

(72) Inventors: Ting-Yun Sasha Huang, Cambridge, MA (US); Tsai-Ta Christopher Lai, Cambridge, MA (US); Matthew Cavallaro, Somerville, MA (US); Russel McAvoy, Sharon, MA (US)

(73) Assignee: AquaFresco, Inc., Somerville, MA (US)

(21) Appl. No.: 15/827,518

(22) Filed: Nov. 30, 2017

Related U.S. Application Data
(60) Provisional application No. 62/521,710, filed on Jun. 19, 2017.
(60) Provisional application No. 62/518,199, filed on Jun. 12, 2017.
(60) Provisional application No. 62/490,669, filed on Apr. 27, 2017.

(51) Int. Cl. C02F 9/00; C02F 1/00; B01D 61/18; B01D 15/08; B01D 65/02

(52) U.S. Cl. CPC C02F 9/00; C02F 1/008; C02F 2103/002; B01D 15/08; B01D 65/02; B01D 61/18

(57) ABSTRACT

Systems, apparatuses and methods related to treating and/or recycling a wastewater for reuse are described.

### CROSS-REFERENCE TO RELATED APPLICATIONS

This Application claims priority under 35 U.S.C. § 119(e) to U.S. Provisional Application Ser. No. 62/490,669, entitled “SELF-CLEANING SOLID FILTRATION SYSTEM FOR WASTEWATER MIXTURES” and filed on Apr. 27, 2017, to U.S. Provisional Application Ser. No. 62/518,199, entitled “IN-SITU ONLINE MONITORING SENSOR FOR WATER QUALITY” and filed on Jun. 12, 2017, and to U.S. Provisional Application Ser. No. 62/521,710, entitled “SMALL-SCALE SMART-CONTROL WATER TREATMENT SYSTEM” and filed on Jun. 19, 2017, each of which is herein incorporated by reference in its entirety.

### FIELD

Disclosed herein are embodiments of apparatuses, methods and systems related to treating and/or recycling a wastewater for reuse.

### BACKGROUND

Over time, water has become a more limited and more expensive resource. Accordingly, it is appropriate or, in some cases, necessary to reduce and reuse water that would otherwise be discharged to the environment. A large portion of water use is directed to cleaning process including laundry, dish-washing, car-wash, and other industrial cleaning process. By some measurements, laundry accounts for over 20% of indoor water consumption. However, in most of the cases, the waste in the cleaning process is a relatively smaller portion (in the case of residential and commercial/on premise laundry, less than 1%).

Accordingly, improved systems directed to the reuse of water, as well as apparatuses and methods for the separation of components in a wastewater stream are needed.

### SUMMARY

Apparatuses, methods and systems related to treating and/or recycling a wastewater for reuse are provided.

In some embodiments, a water reuse system is provided. The system may comprise a point of use having an inlet for receiving a water stream or a treated wastewater stream and an outlet for delivering a wastewater stream. The system may further comprise a control subsystem, comprising: a monitoring sensor configured to measure at least one parameter of the wastewater stream; and a chemical dispenser configured to dispense at least one chemical into the wastewater stream in response to the measured parameter. The system may further comprise a solid filtration module fluidically connected to and downstream of the outlet of the point of use and configured to remove solids from the wastewater stream. The system may further comprise a hydrophobic waste absorption module fluidically connected to and downstream of the outlet of the point of use and configured to absorb hydrophobic waste from the wastewater stream. The control subsystem, the solid filtration module, and the hydrophobic waste absorption module may be configured to produce a treated wastewater stream. The system may further comprise a conduit configured and positioned to receive the treated wastewater stream and recycle the treated wastewater stream to the inlet of the point of use.

In some embodiments, a method of reusing water is provided. The method may comprise introducing a water stream to a point of use to produce a wastewater stream; measuring at least one parameter of the stream with a monitoring sensor; dispensing at least one chemical into the wastewater stream in response to the measured parameter; introducing the wastewater stream to a solid filtration module to remove solids from the wastewater stream; introducing the wastewater stream to a hydrophobic waste absorption module to absorb hydrophobic waste from the wastewater stream; wherein the control subsystem, the solid filtration module, and the hydrophobic waste absorption module produce a treated wastewater stream; and recycling the treated wastewater stream to the point of use.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a flow diagram of a water reuse system with storage tanks, according to one or more embodiments;

FIG. 2 shows a second design of a flow diagram of a water reuse system with storage tanks, according to one or more embodiments;

FIG. 3 shows a flow diagram of a water reuse system without storage tanks, according to one or more embodiments;

FIG. 4 shows a second design of a flow diagram of a water reuse system without storage tanks, according to one or more embodiments;

FIG. 5 shows a top view of a schematic of a monitoring sensor module, according to one or more embodiments;

FIG. 6A shows a top view of a schematic of a monitoring sensor module, according to one or more embodiments;

FIG. 6B shows a side view of a schematic of a monitoring sensor module, according to one or more embodiments;

FIG. 7 shows a top view of a schematic of a monitoring sensor module, according to one or more embodiments;

FIG. 8 shows a cross-section view of a solid filtration device comprising a rotary blade filter, according to one or more embodiments;

FIG. 9 shows a side view of a solid filtration device comprising a rotary blade filter, according to one or more embodiments; and

FIG. 10 shows a side view of a solid filtration device comprising a spray cleaning filter, according to one or more embodiments.

### DETAILED DESCRIPTION

Systems, apparatuses and methods are generally described herein that improve separation of components of a wastewater (e.g., a laundry wastewater), and allow for reuse of the wastewater at a point of use (e.g., a clothes washing machine). In a typical application, the waste component of a laundry wastewater can be lower than 0.1%. However, the entire wastewater is generally discharged after a single use. Accordingly, there is an opportunity to reuse much of a laundry water supply if novel processes and systems are able to be applied. By reducing the amount of water used in the laundry process, the disclosed systems and methods may contribute to improving global water sustainability. It should also be understood, that while many of the systems, apparatuses and methods are described herein in the context of clothes washing, a person of ordinary skill in the art would recognize the disclosures herein could also be applied equally to other fields of use.

According to one or more embodiments, disclosed systems and methods may effectively separate out the waste and/or other components (e.g., detergent) from a wastewater using a combination of controlled chemical reaction processes, mechanical filtration processes, and absorption processes. Furthermore, the system may comprise a control subsystem. The control subsystem may comprise a sensor module and/or chemical dispenser. It may incorporate cloud computing and a machine learning algorithm.

In some embodiments, the disclosed system may comprise a small footprint. For example, the components of the system may be configured to hook on to one single laundry washer, multiple washers, or even be integrated into a properly designed washing machine.

According to one or more embodiments, an integration of chemical reaction, absorption, and/or mechanical filtration processes provides a system that can reuse and recycle laundry wastewater at smaller scale to achieve the maximum amount of water saving and most efficient water treatment process. Unlike the conventional membrane based or bio-reactor water treatment process, the system developed here can operate at low pressure (e.g., at pressures of between 30 and 75 psi (pounds per square inch)), reducing the safety risk and operation cost, which is suitable for laundry wastewater treatment as well as other processes such as dishwashing and other cleaning process.

Systems generally disclosed herein may comprise one or more of the following: water storage tanks (various sizes and numbers of wash water storage tanks, rinse water storage tanks, and buffer tanks etc.), a control subsystem comprising an online monitoring sensor module and chemical dispenser, solid filtration module, oil/hydrophobic absorption module, ultrafiltration/microfiltration module, and ion exchange module. Additional or alternative modules may also be provided. According to one or more embodiments, disclosed systems and methods create a controlled feedback loop system for optimizing the water reuse efficiency. According to some embodiments the system is compact and small enough to be a one-to-one add-on unit for a single washer or multiple washers. For example, according to one or more embodiments, a disclosed system may be integrated into a household washer without significant increase to the physical size or volume of the washer's physical footprint. Descriptions of system components follow.

According to some embodiments, a wastewater reuse system may comprise water storage tanks. The use of water storage tanks in the system have two major functions: (1) as buffer tanks to prevent overflow or storage water for future use; and (2) as containers in which chemical reaction process takes place. Depending on the system design, the size and numbers of water storage tanks will vary in the system.

According to some embodiments, the water reuse system may comprise a control subsystem. The control subsystem may comprise at least one sensor configured to measure a parameter of a water sample, and a controller in communication with one sensor and configured to produce an output signal to control a chemical dispenser and/or system valving in response to an input signal received from the sensor. Additional details of the control system are described further below.

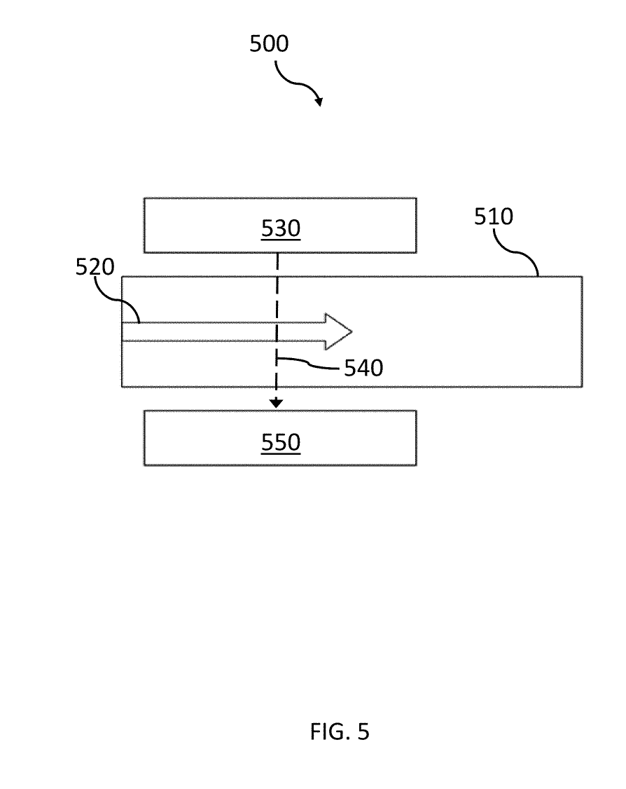

According to one or more embodiments, the control subsystem comprises a novel online monitoring sensor. The sensor may be an optical-based sensor. In some embodiments, the sensor may be configured such that it may be trained with training dataset using machine learning/parameter fitting algorithm specific to the targeted wastewater (e.g., laundry wastewater). The sensor module may conduct in-situ monitoring on the water quality, stain level, chemical concentration information and automatically control the chemical dispensing system to dose the right amount of chemicals in the wastewater for treatment. Embodiments of the monitoring sensor are discussed further below in view of FIGS. 5-7.

According to one or more embodiments, the control subsystem further comprises a chemical dispenser. The chemical dispensing system is controlled by the online monitoring sensor module to dose the right amount of chemicals for water treatment process. The module may disperse different chemicals in response to information received from the online monitoring sensor. Chemicals which may be dispensed include, without limitation: aluminum or iron based polyelectrolytes, detergents (in liquid or solid form), softener, bleach, and other anionic/cationic polyelectrolytes or surfactants.

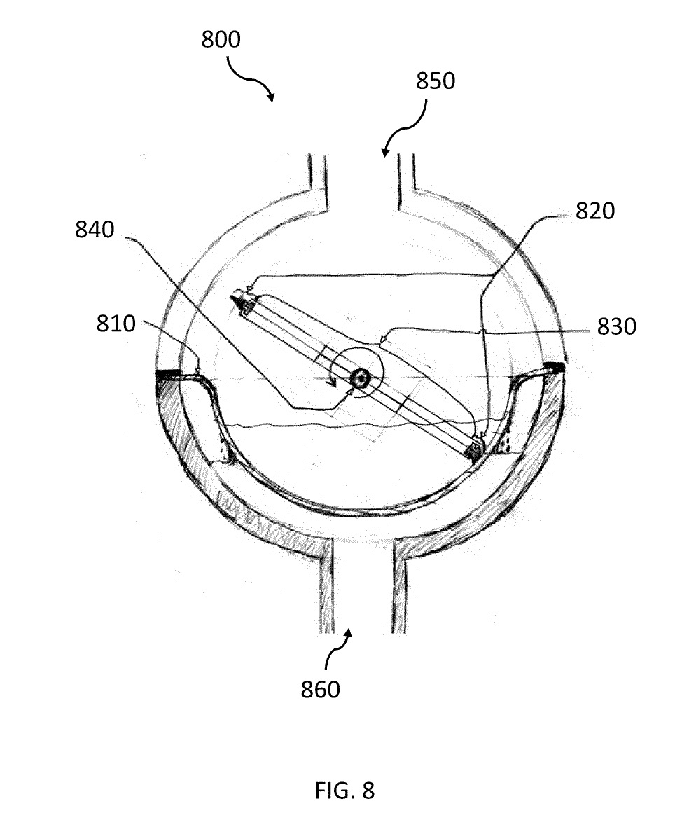

In some embodiments, a solid filtration module is provided. The solid filtration module can effectively remove the precipitates from the chemical reaction process, lint in the wastewater, and other fine particles in the system. In some embodiments, the solid filtration module is equipped with self-cleaning function, as a result minimal maintenance is needed from the operator. Embodiments of the solid filtration module are discussed further below in view of FIGS. 8-10.

In some embodiments, an oil/hydrophobic waste absorption module is provided. This module may remove the residual hydrophobic waste in the system via an absorption mechanism. The pressure drop for the oil absorption module is minimal and can be operated at low pressure. Examples of compositions and methods related to the hydrophobic waste absorption module are described in PCT International Publication No. WO2016/044620, entitled, “MEDIA, SYSTEMS, AND METHODS FOR WASTEWATER REGENERATION,” which is incorporated herein by reference in its entirety and for all purposes. The hydrophobic waste module may comprise filtration media positioned within a housing. The filtration media may comprise an oleophilic foam substrate and a hydrophobic coating on the oleophilic foam substrate. The filtration media may be configured to separate a hydrophobic component from the wastewater stream to produce filtrate comprising water and surfactant. A method of using this module to treat a water stream may comprise absorbing a majority of the hydrophobic material into an oleophilic-polymer-based foam filter; and rejecting a majority of the water and surfactant from absorption onto the foam filter to produce a filtrate stream comprising water and/or surfactant. The foam-based filter removes hydrophobic compounds from the process wastewater while allowing for further use of the remaining water and surfactant.

In some embodiments of the water reuse system, an ultrafiltration or microfiltration module is provided. This module may be used for bacteria/microorganism removal. In embodiments also incorporating a solid filtration module, the presence of the solid filtration module upstream of the ultra- or microfiltration module reduces the strain on the latter module and may aid in extending the life of the ultra- or microfilter which will not be clogged as easily. Furthermore, in some embodiments, the ultrafiltration or microfiltration module may be self-cleaning further increasing the lifetime of the filter. As used herein, “ultrafiltration” and “microfiltration” refers to a form of membrane filtration in which forces such as pressure or concentration gradient lead to a separation through a semipermeable membrane. Suspended solids and solutes of high molecular weight are retained, while water and low molecular weight solutes may pass through the membrane. “Ultrafiltration” refers to a unit in which the membrane has a pore size of less than 0.001 μm to 0.1 μm. “Microfiltration” refers to a unit in which the membrane has a pore size of 0.1 μm to 10 μm.

In some embodiments, an ion-exchange module is provided. The module may comprise ion-exchange resin. Ion-exchange resin may be used to remove excess ions, and may be selected according to the needs of a system as would be understood by a person of ordinary skill in the art. For example, in embodiments in which recycle water is stored for a long period of time, salts/ions build-up might be an issue. Ion exchange resin may be used in such embodiments to remove excess ions and prevent build-up issues that might otherwise occur.

With regard to the use of the disclosed systems in laundry, a normal laundry process usually comprises one wash cycle (water plus detergent and other chemicals), and multiple rinse cycles (tap water only). According to one set of embodiments for moderate to large scale laundry processes such as commercial laundry, coin-opt laundry, or large scale such as linen service companies, a disclosed system may be designed to reuse both the wash and rinse water for subsequent loads of laundry. In such embodiments, the water may be stored in water storage tanks for the next use.

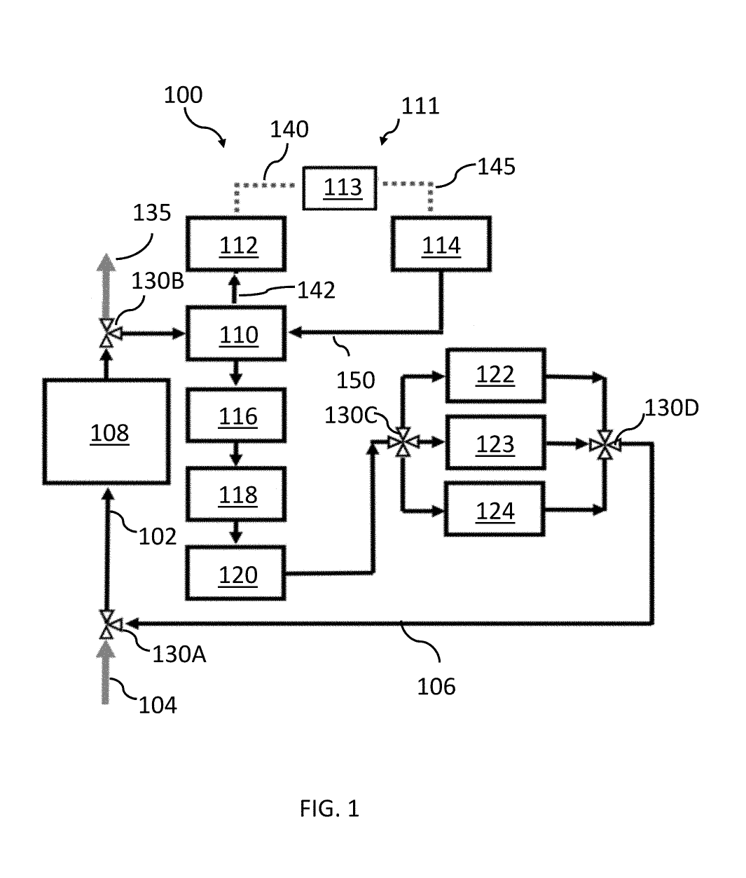

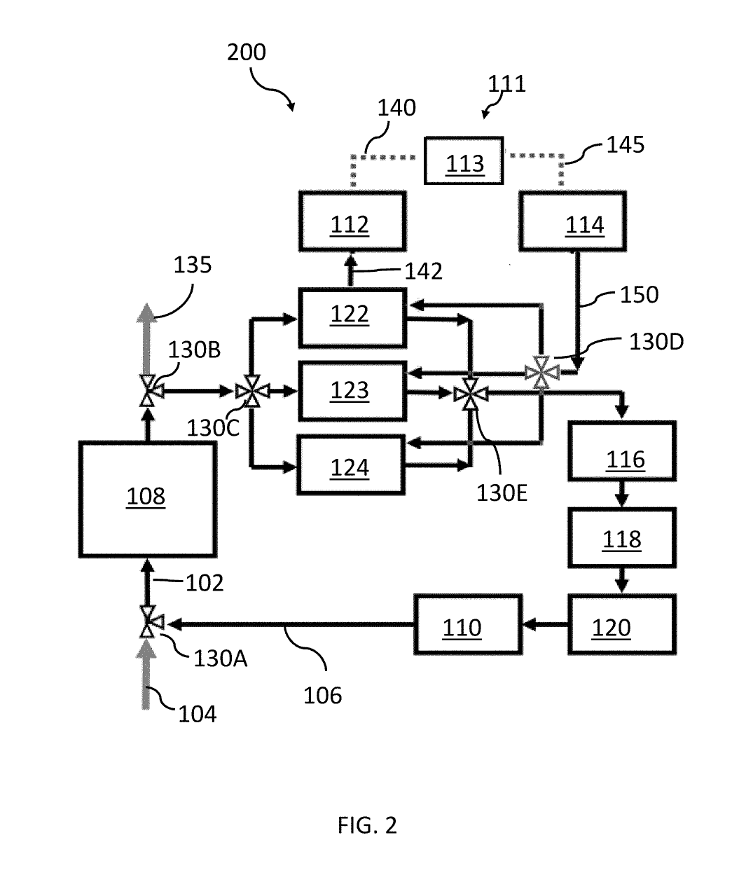

Turning to the drawings, FIGS. 1 and 2 are representative embodiments of water reuse systems that comprise storage tanks. Use of storage tanks may aid in maximum water reuse. In FIG. 1, a water reuse system 100 comprises a point of use 108 that requires water to operate. Examples of potential points of 108 include, without limitation, one or more clothes washing machines, dishwashing machines, car washing machines, or an alternative industrial application requiring water.

A water stream is delivered to an inlet of the point of use 108 via conduit 102. The water may comprise fresh water from conduit 104 or treated wastewater via conduit 106 that has been recycled or a mixture of fresh and treated water. Valving 130A controls the introduction of fresh or treated water.

After the operation requiring water at the point of use 108 is complete, valving 130B is used to direct the flow of wastewater from an outlet of the point of use 108. The wastewater may be sent to drain 135 or sent to a buffer tank 110 for treatment.

A control subsystem 111 associated with the water reuse system 100 and discussed throughout this disclosure comprises a controller 113, a monitoring sensor 112, and a chemical dispenser 114.

The monitoring sensor 112 measures one or more parameters of a sample of wastewater delivered via conduit 142 and produces an input signal 140 to controller 113. As a result of this measurement, an output signal 145 is produced directing the chemical dispenser 114 to dispense at least one chemical into the wastewater stream via conduit 150, in response to the measured parameter(s). The dosage of chemical may be controlled by the controller 113 using a trained dataset.

The wastewater is then directed to treatment modules 116, 118, 120 fluidly connected to and downstream of the outlet of the point of use 108 and the buffer tank 110. A solid filtration module 116 removes solids, such as solid particles and lint from the wastewater. A hydrophobic waste absorption module 118 absorbs hydrophobic waste, such as oil and other organic waste, from the wastewater stream. An ultrafiltration/microfiltration module 120 removes microorganisms, such as bacteria, from the wastewater stream. These and other modules (such as ion exchange resin) may be incorporated into the system 100 and are further described throughout this disclosure Likewise, one or more of the above modules may be removed, according to the needs of the system.

The control subsystem 111 and treatment modules 116, 118, 120 produce a treated wastewater stream that may be recycled to the point of use via conduit 106. To further increase the water use efficiency, treated water may be stored in storage tanks 122, 123, and/or 124 rather than be recycled immediately. Valving 130C and 130D controls the introduction of water to and from the storage tanks 122, 123, and 124. When the point of use 108 enters a new stage or round of operation water from one of the storage tanks 122, 123, and 124 may be delivered to the point of use 108 reducing or eliminating the amount of fresh water required via conduit 104, improving the overall water efficiency of the system. Different storage tanks may serve different treated streams of water. For example, in embodiments in which the point of use 108 is a clothes washing machine, storage tank 122 may store a water for use in a wash cycle that includes a detergent component, while storage tanks 123 and 124 may store a water for use in a rinse cycle in which the detergent component has been removed. The system 100 and related process can potentially save around 90% of the water when compared to the current laundry process. Analogous strategies can be employed when the point of use 108 is other than a clothes washing machine.

FIG. 2 shows an embodiment of a water reuse system 200 with many of the same or similar components as the system 100 shown in FIG. 1 arranged in an alternative manner. The system 200 shown in FIG. 2 differs from system 100 notably in the fact that the storage tanks 122, 123, and 124, are positioned upstream of modules 116, 118, and 120, while the buffer tank 110 is positioned downstream. In this alternative arrangement, water may be stored first and then treated in the respective modules 116, 118, 120 before delivery to the point of use 108. Valving 130C and 130E directs the flow of water to and from the storage tanks to the modules, while valving 130D directs flow of treatment chemicals from the chemical dispenser 114 through conduit 150. A buffer tank 110 may be used to regulate flow.

It should be understood that the number of washers and water and other aspects of the configuration may vary from the embodiments shown in the FIGS. 1 and 2, depending on the needs of the user.

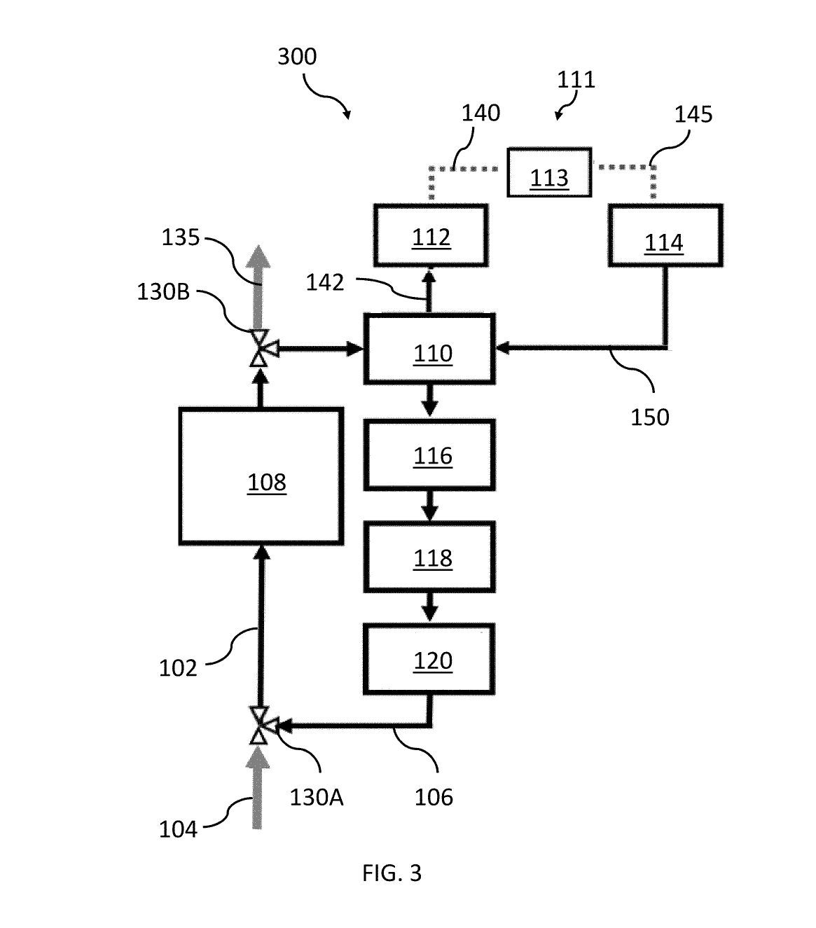

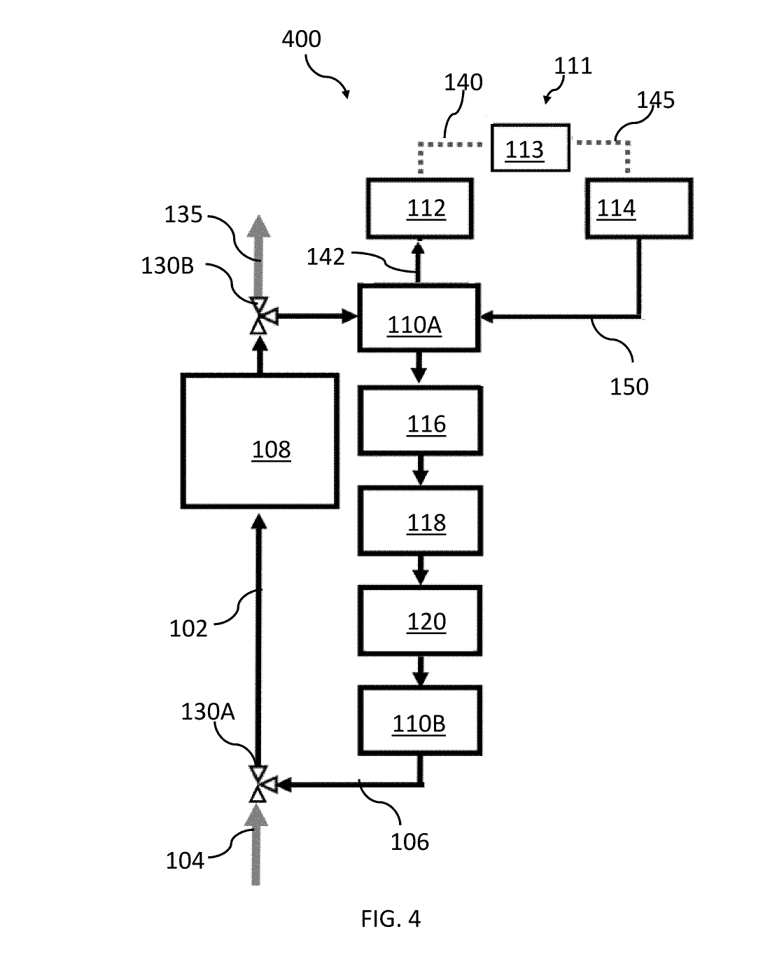

FIGS. 3 and 4 show embodiments of a water reuse system 300 and 400, respectively, designed without prolonged storage. Such embodiments may be employed, for example, where the presence of additional storage tanks is undesirable, such as might be the case in a residential setting, where space is limited.

FIG. 3 shows an embodiment of a water reuse system 300 with many of the same or similar components as the systems 100 and 200 shown in FIGS. 1 and 2, but without storage tanks 122, 123, and 124. As shown in FIG. 3 the system 300 comprises a point of use 108, such as a clothes washing machine, that requires water to operate.

After the operation requiring water at the point of use 108 is complete, valving 130B is used to direct the flow of wastewater from an outlet of the point of use 108. The wastewater may be sent to drain 135 or sent to a buffer tank 110 for treatment under the control subsystem 111 as described above.

The wastewater is then directed to treatment modules 116, 118, 120 fluidly connected to and downstream of the outlet of the point of use 108 and the buffer tank 110. In the embodiment shown, the system 300 comprises a solid filtration module 116, a hydrophobic waste absorption module 118 and an ultrafiltration/microfiltration module 120 removes microorganisms, such as bacteria, from the wastewater stream. However, additional or alternative modules (such as ion exchange resin) may be incorporated into the system 300.

As in the systems 100 and 200 of FIGS. 1 and 2, the control subsystem 111 and treatment modules 116, 118, 120 produce a treated wastewater stream that may be recycled to the point of use via conduit 106. The system 300 and related process can potentially save around 90% of the water when compared to the current laundry process. Analogous strategies can be employed when the point of use 108 is other than a clothes washing machine.

The embodiment of a water reuse system 400, as shown in FIG. 4 is similar to that shown in FIG. 3, with the difference being that system 400 comprises two buffer tanks 110A and 110B, with the second buffer tank 110B helping to regulate the flow of treated wastewater back to the point of use 108.

In either of the systems 300 or 400, the water is regenerated after each cycle and used immediately in the following cycles. For example, where the point of use 108 is a clothes washing machine, it may have the following common laundry settings: 1 wash load (tap water and detergent), followed by two rinse loads (tap water only). The systems 300 and 400 will treat the wash water right after it comes out from the washer, and as soon as it is treated, it will immediately go back as the first rinse cycle. When the rinse water is discharged from the washer, it will go through the same process as the wash water and subsequently being used as the water for the second rinse. After the washing cycle is completed, the water is then discharged into the drain. In some embodiments, it is estimated that a system and process such as that described with relation to FIGS. 3 and 4 may save around 50 to 60% of the water, compared to generally known processes that dispose of the water between cycles.

According to one or more embodiments, a control subsystem is provided. The control subsystem may comprise a monitoring sensor and a chemical dispenser. FIGS. 5-7 show embodiments of a sensor for use in the water reuse system according to one or more embodiments.

The monitoring sensor may be configured to measure at least one parameter of the wastewater stream. In some embodiments the monitoring sensor may be configured to measure a number of parameters. Examples of parameters that may be monitored or measured by the monitoring sensor include the levels of different components within the wastewater, such as waste, stain, various kind of dyes, hydrophobic components, surfactants, etc.

In some embodiments, novel sensor technology is provided. Use of an improved sensor may contribute to improved performance of the disclosed systems and/or allows for reduced costs. The monitoring sensor is capable of separately measuring different components present in a wastewater stream. For example, the monitoring sensor may be configured to distinguish the aforementioned compositions with specific training data sets. Unlike typical sensors that might be used to monitor a wastewater, which usually take measurements from a full spectrum, the provided sensor may be configured to measure only specific wavelengths that are targeted as being of interest. For example, through a combination of different electromagnetic spectrum measurements such as UV-Vis, fluorescence, visible light, and/or color spectrum, the key parameters of the wastewater may be identified in an efficient, low-cost, and accurate manner. By targeting only certain wavelength of interest, hardware costs associated with the sensor may be limited. In some embodiments, the sensor may employ a machine learning model and algorithm to accurately distinguish the different components of the wastewater.

In some embodiments, the sensor may evaluate water quality to determine whether a particular water stream is fit for reuse at a point of use (such as a laundry machine). In some embodiments, the sensor may be used as an indicator and guideline for the wastewater treatment process. In response to a measurement of a parameter from the monitoring sensor, an associated chemical dispenser may dispense one or more treatment chemicals into the wastewater stream to remove or neutralize an undesired component in the stream.

In some embodiments, the sensor may comprise an optical spectrometer. The sensor may operate by analyzing the absorption of light through a water sample and comparing that to the absorption spectrum of pure water. The sensor may be configured to measure only a few specific wavelengths of the electromagnetic spectrum in the range of interests. The sensor may be designed in such a way that both the total number of wavelengths that are measured and the particular wavelengths designated to be measured can be changed to best match the waste components in the wastewater.

According to one or more embodiments, the physical layout of the sensor comprises an LED array and a photodiode array aligned across from one another with a transparent conduit positioned therebetween. This assembly may be placed in an opaque housing to prevent external light from affecting the measurements. In some embodiments, the ends of the assembly use a compression based fitting and/or a threaded end piece to allow a conduit, such as a square quartz tube (or any tube that is transparent in the targeted wavelengths), to connect to rubber tubing through which a water sample is transferred. The sensor may use a peristaltic pump or any other suitable mechanical methods to move samples through the sensor.

The sensor may directly measure transmittance of ultraviolet and visible light through a sample contained in a transparent conduit. The specific wavelengths of electromagnetic radiation used in the measuring process may be generated by LEDs or any other suitable source. The amount of light transmitted through the sample is measured using a photodiode that is specific to that region of the spectrum. The current generated by the photodiode may be amplified and converted to voltage by, for example, an inverting closed-loop operational amplifier (op-amp). The resultant voltage may be measured via an analog-to-digital converter (ADC) connected to a microcontroller unit (MCU). The MCU may be connected to a storage and data processing platform. The platform may be a cloud-based storage and data processing platform.

The measurements made by the sensor are analyzed with a machine learning algorithm which determines whether or not the water can be reused. The algorithm may employ a neural network to calculate the water's potential for reuse or the required chemical dosing for treating the water.

As an example of one embodiment of such a sensor, FIG. 5 shows a top view of a schematic for a sensor 500. A transparent conduit 510 carries a sample water 520. An LED or LED array 530 emits electromagnetic radiation 540 at a desired wavelength (either within or outside of the visible light spectrum), or set of wavelengths, through the conduit 510 and sample water 520, which are then absorbed on the photodiode or photodiode array 550. An opaque housing for the sensor is not shown. Also not shown are additional devices associated with and/or connected to the photodiode array such as an amplifier, converter, and/or microcontroller.

According to one or more embodiments, a sensor may be employed to measure one or more parameters of the water through use of a camera. Such a sensor may comprise one or more LEDs and a camera. A method for using the sensor may comprise applying one or more colors of light to the sample with one or more LEDs (e.g., RGB LEDs and/or fluorescent LEDs) and taking images of the water sample with the camera while the light is applied. The images may then be processed using image processing algorithms and converted from, for example, Blue Green Red (BGR) format to, for example, Hue Saturation Value (HSV) format. The hue and value channels may then be analyzed to identify any relevant changes in appearance such as a decrease or increase in value under certain colors of light or variations in the hue. The method may be used to measure at least one parameter (e.g., component makeup) of the waste stream water. The water may be treated with a chemical dispensed from an associated chemical dispenser in response to the measured parameter(s), and/or the system's valving may be controlled to direct the wastewater stream for reuse or to waste in response to the measured parameter(s).

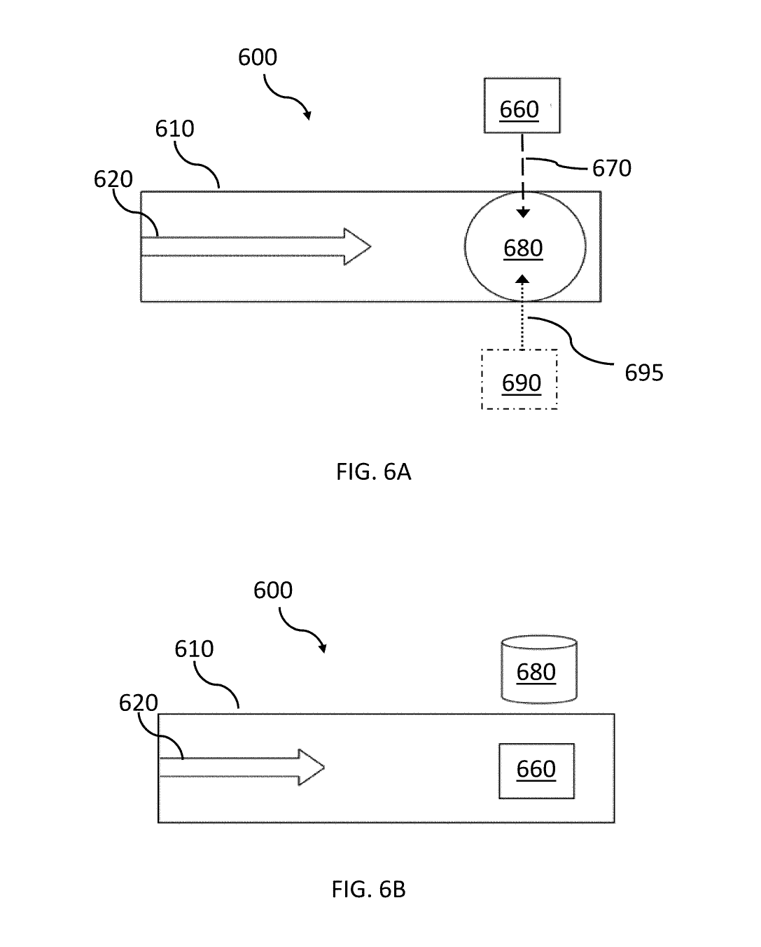

As an example of one embodiment of such a sensor, FIGS. 6A and 6B show a top view and side view, respectively, of a schematic for a sensor 600. A transparent conduit 610 contains a sample water 620. One or more RGB LEDs 660 emits electromagnetic radiation 670 at a desired wavelength, or set of wavelengths, through the conduit 610 and sample water 620, images of which are then taken by camera 680 for processing. The LEDs may emit RGB or fluorescent light. The LED and camera at right angles to each other. The RGB LED may be separated from the sample 620 by a diffuser (not shown). The sensor 600 may further comprise n optional second fluorescent LED or LED array 690, emitting a second set of electromagnetic radiation 695.

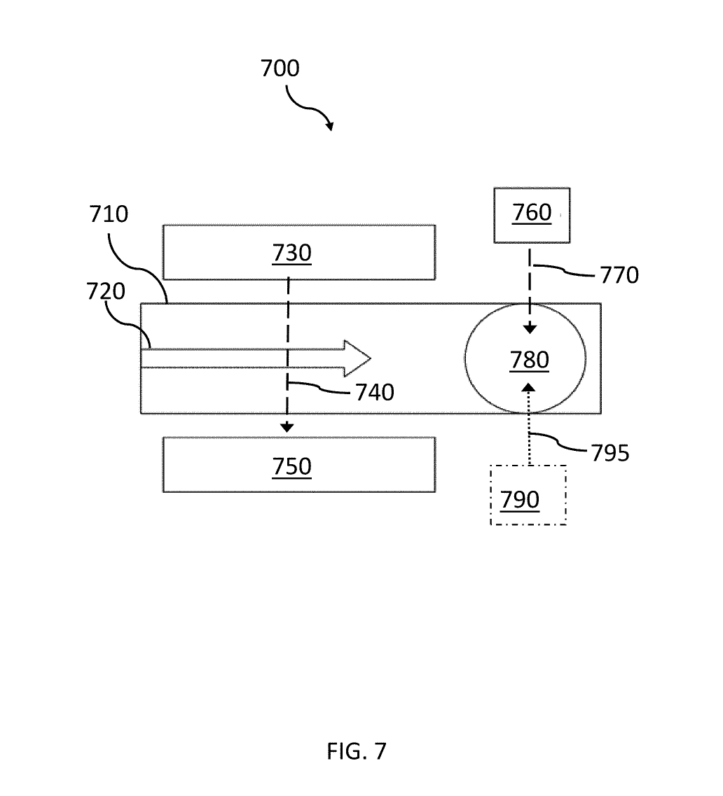

According to one or more embodiments, elements of the sensors may be combined. For example, FIG. 7 shows an embodiment of a sensor 700 comprising both a photodiode array 750 configured to receive electromagnetic radiation 740 from an associated LED array 730 and a camera 780 configured to take images of a water sample 720 contained in a transparent conduit 710, while the water 720 is lit radiation 770 by array 770. An optional second LED array 790 may emit radiation 795 through the water sample 720.

An opaque housing for the sensors of FIGS. 5-7 is not shown. Also not shown in FIGS. 5-7 are additional devices associated with and/or connected to the photodiode array, LED array, or camera such as an amplifier, converter, or microcontroller.

FIGS. 8-10 show embodiments of solid filtration modules that may be incorporated into the water reuse system. According to some embodiments, the solid filtration module may comprise a novel solid filtration device with a self-cleaning capability.

In some embodiments, the self-cleaning mechanism may comprise a rotating scraper. In some embodiments, the self-cleaning mechanism may comprise a spray-cleaning subsystem. In some embodiments, the self-cleaning mechanism may comprise an air-blown subsystem that will remove the solid waste from a filter mesh. In some embodiments, the self-cleaning mechanism may comprise a thermal/electrical subsystem that will remove the solid waste from the filter. Combinations of these self-cleaning mechanism are also possible.

The disclosed solid filtration module may effectively separate out the solid, lint, and small particles from the wastewater stream and meanwhile automatically clean the solid filtration unit without requiring a manual cleaning process. The solid filtration module may be integrated into a small-scale water reuse system such as the embodiments shown in FIGS. 3 and 4, or be scaled up for larger facilities, such as the embodiments shown in FIGS. 1 and 2. In either case, the solid filtration module may be configured to filter solid waste from the wastewater and remove the filtered solids from the module in a continuous or intermittent way.

According to one or more embodiments, the solid filtration unit comprises a mesh filter. The mesh filter may have a pore size selected to optimize removal of the lint from the wall of a circular tube, and a rotating mechanical scraper scrapes the solid waste from the filter mesh to continuously clean the filter. According to one or more embodiments, a liquid backwash subsystem is provided to remove the solid waste from the filter mesh. According to one or more embodiments, an air-blown subsystem is provided to remove the solid waste from the filter mesh. According to one or more embodiments, an thermal/electrical subsystem is provided to remove the solid waste from the filter mesh. Furthermore, in some embodiments, one or more of the above mechanisms may be combined in a single solid filtration module.

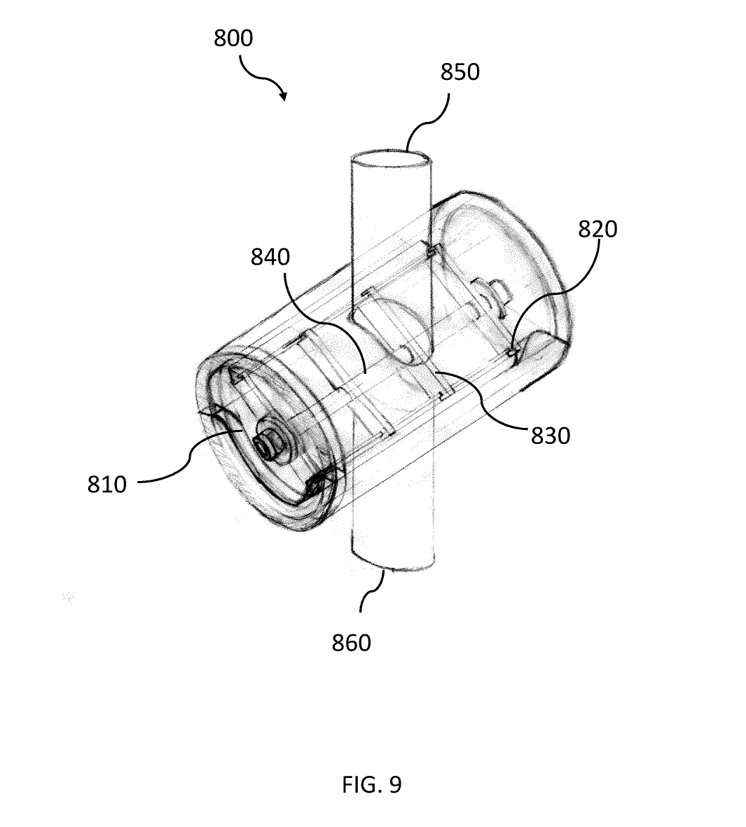

Referring to FIGS. 8 and 9, a solid filtration module 800 comprises a filter 810 of a certain pore size that physically separates fluid from solids. The filter 810 may be a woven mesh or perforated surface, or other material. The filter 810 may be composed of a material or combination of materials including but not limited to stainless steel, other metals, polymers, ceramics, and any combination of the above. The pore size of the filter may be between 0.1 and 1000 microns. Other pore sizes are also possible. According to some embodiments, the filter could take the shape of a half cylinder, full cylinder, or any fraction of any surface of revolution or any other shape of any dimensions, or any composite shape consisting of any combination of the above. The filter material may be flexible or rigid. It may also be supported by an additional structure to increase its rigidity and strength.

According to one or more embodiments, fluid flow through the filter may be achieved by gravity, negative gage pressure from a pump, positive gage pressure from a pump, or any readily available method as would be understood by a person of ordinary skill in the art. The fluid may be water, as in the reuse systems discussed herein. Alternatively, the disclosed filtration module may be used in alternative applications where the fluid is ethanol, air, liquid or gaseous hydrocarbons, or any other fluid.

Returning to FIGS. 8 and 9, a rotating scraper 820 removes the solids from the surface of the filter 810, preventing it from clogging. The scrapers may comprise rubber, elastomer, or any other suitable material or combination of materials. The scrapers may be part of a rotor 830 coupled to a drive shaft 840 driven by an electric motor (not shown), or made to rotate via an alternative mechanism. Influent enters the solid filtration module 800 at an inlet 850 while effluent exits the module at an outlet 860. There could be any positive integer number of scrapers, each being of either the same or of different shape and size from the others.

A variety of options may be employed to remove solids from the scraper 820. Such options (not shown) include a stationary blade that scrapes solids off the rotary blades into a waste receptacle, by the draining of the concentrated, suspended solid-fluid mixture out of the device, by the flushing of solids out of the device with fresh fluid, by the back-flowing of fluid through the filter, by any other means, or by any combination of the above. The removed solids could include lint, zeolites, salts, pigments, stains, insoluble organic matter, microorganisms, any other solid present in the fluid, or any combination of the above.

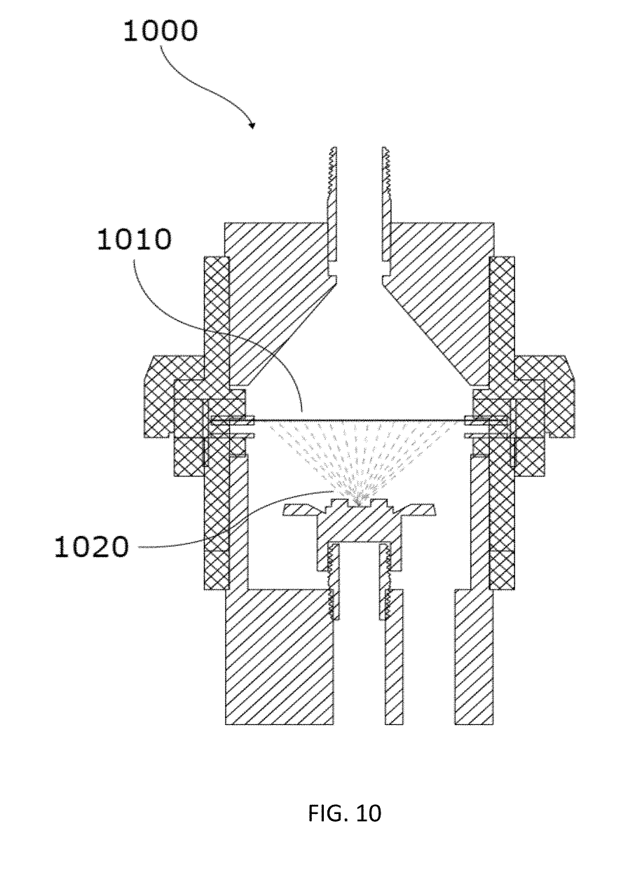

FIG. 10 illustrates an embodiment of the solid filtration module 1000, according to one or more embodiments, in which the self-cleaning mechanism for filter 1010 comprises a spraying unit 1020. The device contains a filter 1010 of a certain pore size that physically separates fluid from solids. This includes but is not limited to woven meshes and perforated surfaces. This filter could be composed of a material or combination of materials including but not limited to stainless steel, other metals, polymers, ceramics, and any combination of the above. The pore size of the filter could be between 0.1 and 1000 microns or any other size. The filter can be oriented horizontally, vertically, or at any angle. A fluid sprayer 1020 removes trapped solids from the filter 1010, preventing it from clogging. The spray can be created by releasing pressurized fluid through a nozzle or by any other suitable means. The fluid used in the spray can be the same or different than the fluid from which the solids were filtered. Multiple sprays may also be used simultaneously or individually with one or more fluids at one or more pressures and temperatures.

Solids can be removed from the module 1000 by draining the concentrated, suspended solid-fluid mixture out of the device, by flushing the solids out of the device with fresh fluid from the spray nozzle and/or from any other source, by back-flowing fluid through the filter, or by an alternative approach, or by any combination of the above. The removed solids could include lint, zeolites, salts, pigments, stains, insoluble organic matter, microorganisms, any other solid present in the fluid, or any combination of the above.

As described above, certain embodiments of the inventive systems include one or more computer implemented control systems for operating various components of the water treatment system, (e.g., controller 113 of the computer implemented control subsystem 111 shown in FIGS. 1-4). In general, any calculation methods, steps, simulations, algorithms, systems, and system elements described herein may be implemented and/or controlled using one or more computer implemented control system(s), such as the various embodiments of computer implemented systems described below. The methods, steps, control systems, and control system elements described herein are not limited in their implementation to any specific computer system described herein, as many other different machines may be used.

The computer implemented control system can be part of or coupled in operative association with a unit operation of a water treatment system and/or other automated system components, and, in some embodiments, is configured and/or programmed to control and adjust operational parameters, as well as analyze and calculate values. In some embodiments, the computer implemented control system(s) can send and receive reference signals to set and/or control operating parameters of system apparatus. In other embodiments, the computer implemented system(s) can be separate from and/or remotely located with respect to the other system components and may be configured to receive data from one or more systems of the invention via indirect and/or portable means, such as via portable electronic data storage devices, such as magnetic disks, or via communication over a computer network, such as the Internet or a local intranet.

The computer implemented control system(s) may include several known components and circuitry, including a processing unit (i.e., processor), a memory system, input and output devices and interfaces (e.g., an interconnection mechanism), as well as other components, such as transport circuitry (e.g., one or more busses), a video and audio data input/output (I/O) subsystem, special-purpose hardware, as well as other components and circuitry, as described below in more detail. Further, the computer system(s) may be a multi-processor computer system or may include multiple computers connected over a computer network.

In typical industrial systems, the type of computer used may be a Programmable Logic Controller (PLC), for example, an Allen-Bradley ControlLogix 1756-L71. PLCs may run extremely stable operating systems designed for deterministic logic execution and contain hardware with high tolerance to temperature, humidity, and vibration.

In some embodiments, the ControlLogix 1756 runs VxWorks operating system, has a ControlLogix processor, and can be connected to over 100,000 digital inputs and outputs (I/O) and 4000 analog I/Os. PLCs generally utilize Ladder Logic programming.

In some embodiments, the PLC may run a proportional, integral, derivative (PID) control system. Input may come from one of the sensors described above, and the controller may output a signal to a pump or to a valve.

The computer implemented control system(s) may include a processor, for example, a commercially available processor such as one of the series x86, Celeron and Pentium processors, available from Intel, similar devices from AMD and Cyrix, the 680X0 series microprocessors available from Motorola, and the PowerPC microprocessor from IBM. Many other processors are available, and the computer system is not limited to a particular processor.

A processor typically executes a program called an operating system, of which WindowsNT, Windows95 or 98, Windows XP, Windows Vista, Windows 7, UNIX, Linux, DOS, VMS, MacOS and OS8 are examples, which controls the execution of other computer programs and provides scheduling, debugging, input/output control, accounting, compilation, storage assignment, data management and memory management, communication control and related services. The processor and operating system together define a computer platform for which application programs in high-level programming languages are written. The computer implemented control system is not limited to a particular computer platform.

The computer implemented control system(s) may include a memory system, which typically includes a computer readable and writeable non-volatile recording medium, of which a magnetic disk, optical disk, a flash memory and tape are examples. Such a recording medium may be removable, for example, a floppy disk, read/write CD or memory stick, or may be permanent, for example, a hard drive.

Such a recording medium stores signals, typically in binary form (i.e., a form interpreted as a sequence of one and zeros). A disk (e.g., magnetic or optical) has a number of tracks, on which such signals may be stored, typically in binary form, i.e., a form interpreted as a sequence of ones and zeros. Such signals may define a software program, e.g., an application program, to be executed by the microprocessor, or information to be processed by the application program.

The memory system of the computer implemented control system(s) also may include an integrated circuit memory element, which typically is a volatile, random access memory such as a dynamic random access memory (DRAM) or static memory (SRAM). Typically, in operation, the processor causes programs and data to be read from the non-volatile recording medium into the integrated circuit memory element, which typically allows for faster access to the program instructions and data by the processor than does the non-volatile recording medium.

The processor generally manipulates the data within the integrated circuit memory element in accordance with the program instructions and then copies the manipulated data to the non-volatile recording medium after processing is completed. A variety of mechanisms are known for managing data movement between the non-volatile recording medium and the integrated circuit memory element, and the computer implemented control system(s) that implements the methods, steps, systems control and system elements control described above is not limited thereto. The computer implemented control system(s) is not limited to a particular memory system.

At least part of such a memory system described above may be used to store one or more data structures (e.g., look-up tables) or equations such as calibration curve equations. For example, at least part of the non-volatile recording medium may store at least part of a database that includes one or more of such data structures. Such a database may be any of a variety of types of databases, for example, a file system including one or more flat-file data structures where data is organized into data units separated by delimiters, a relational database where data is organized into data units stored in tables, an object-oriented database where data is organized into data units stored as objects, another type of database, or any combination thereof.

The computer implemented control system(s) may include one or more output devices. Example output devices include a cathode ray tube (CRT) display, liquid crystal displays (LCD) and other video output devices, printers, communication devices such as a modem or network interface, storage devices such as disk or tape, and audio output devices such as a speaker.

The computer implemented control system(s) also may include one or more input devices. Example input devices include a keyboard, keypad, track ball, mouse, pen and tablet, communication devices such as described above, and data input devices such as audio and video capture devices and sensors. The computer implemented control system(s) is not limited to the particular input or output devices described herein.

It should be appreciated that one or more of any type of computer implemented control system may be used to implement various embodiments described herein. Aspects of the invention may be implemented in software, hardware or firmware, or any combination thereof. The computer implemented control system(s) may include specially programmed, special purpose hardware, for example, an application-specific integrated circuit (ASIC). Such special-purpose hardware may be configured to implement one or more of the methods, steps, simulations, algorithms, systems control, and system elements control described above as part of the computer implemented control system(s) described above or as an independent component.

The computer implemented control system(s) and components thereof may be programmable using any of a variety of one or more suitable computer programming languages. Such languages may include procedural programming languages, for example, LabView, C, Pascal, Fortran and BASIC, object-oriented languages, for example, C++, Python, Java and Eiffel and other languages, such as a scripting language or even assembly language.

The methods, steps, simulations, algorithms, systems control, and system elements control may be implemented using any of a variety of suitable programming languages, including procedural programming languages, object-oriented programming languages, other languages and combinations thereof, which may be executed by such a computer system. Such methods, steps, simulations, algorithms, systems control, and system elements control can be implemented as separate modules of a computer program, or can be implemented individually as separate computer programs. Such modules and programs can be executed on separate computers.

Such methods, steps, simulations, algorithms, systems control, and system elements control, either individually or in combination, may be implemented as a computer program product tangibly embodied as computer-readable signals on a computer-readable medium, for example, a non-volatile recording medium, an integrated circuit memory element, or a combination thereof. For each such method, step, simulation, algorithm, system control, or system element control, such a computer program product may comprise computer-readable signals tangibly embodied on the computer-readable medium that define instructions, for example, as part of one or more programs, that, as a result of being executed by a computer, instruct the computer to perform the method, step, simulation, algorithm, system control, or system element control.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, apparatus, and/or method described herein. In addition, any combination of two or more such features, systems, apparatuses, and/or methods, if not mutually inconsistent, is included within the scope of the present invention. Accordingly, the foregoing description and drawings are by way of example only.

What is claimed is:

1. A water reuse system, comprising:
a point of use having an inlet for receiving a water stream or a treated wastewater stream and an outlet for delivering a wastewater stream;
a control subsystem, comprising:
a monitoring sensor configured to measure at least one parameter of the wastewater stream; and
a chemical dispenser configured to dispense at least one chemical into the wastewater stream in response to the measured parameter;
a solid filtration module fluidically connected to and downstream of the outlet of the point of use and configured to remove solids from the wastewater stream;
a hydrophobic waste absorption module fluidically connected to and downstream of the outlet of the point of use and configured to absorb hydrophobic waste from the wastewater stream,
wherein the control subsystem, the solid filtration module, and the hydrophobic waste absorption module are configured to produce a treated wastewater stream; and
a conduit configured and positioned to receive the treated wastewater stream and recycle the treated wastewater stream to the inlet of the point of use.

2. The system of claim 1 wherein the point of use is one of a clothes washing machine, a dishwashing machine, or a car washing machine.

3. The system of claim 1, wherein the point of use is a clothes washing machine.

4. The system of claim 1, further comprising an ultrafiltration module or a microfiltration module fluidically connected to and downstream of the outlet of the point of use and configured to remove microorganisms from the wastewater stream.

5. The system of claim 1, further comprising one or more storage tanks fluidically connected to and downstream of the outlet of the point of use and positioned to receive and store one of the wastewater stream or the treated wastewater stream.

6. The system of claim 5, wherein at least of the one or more storage tanks comprises a wash cycle storage tank positioned to receive and store one of the wastewater stream or the treated wastewater stream configured for use during a wash cycle of the point of use.

7. The system of claim 5, wherein at least of the one or more storage tanks comprises a rinse cycle storage tank positioned to receive and store one of the wastewater stream or the treated wastewater stream configured for use during a rinse cycle of the point of use.

8. The system of claim 1, wherein the monitoring sensor comprises one or more light-emitting diodes and one or more photodiodes positioned on opposite sides of a wastewater sample.

9. The system of claim 1, wherein the monitoring system comprises one or more light-emitting diodes configured to emit light through a wastewater sample and a camera configured to produce images of the illuminated wastewater sample.

10. The system of claim 1, wherein the solid filtration module is self-cleaning.

11. A method of reusing water, comprising:
introducing a water stream to a point of use to produce a wastewater stream;
measuring at least one parameter of the stream with a monitoring sensor;
dispensing at least one chemical into the wastewater stream in response to the measured parameter;
introducing the wastewater stream to a solid filtration module to remove solids from the wastewater stream;
introducing the wastewater stream to a hydrophobic waste absorption module to absorb hydrophobic waste from the wastewater stream;
wherein the control subsystem, the solid filtration module, and the hydrophobic waste absorption module produce a treated wastewater stream; and
recycling the treated wastewater stream to the point of use.

12. The method of claim 8, wherein the point of use is one of a clothes washing machine, a dishwashing machine, or a car washing machine.

13. The method of claim 8, wherein the point of use is a clothes washing machine.

14. The method of claim 8, further comprising introducing the wastewater stream to an ultrafiltration module or a microfiltration module fluidically connected to and downstream of the outlet of the point of use and configured to remove microorganisms from the wastewater stream.

15. The method of claim 8, further comprising storing in one or more storage tanks one of the wastewater stream or the treated wastewater stream prior to recycling the treated wastewater stream to the point of use.

16. The method of claim 15, wherein at least of the one or more storage tanks comprises a wash cycle storage tank positioned to receive and store one of the wastewater stream or the treated wastewater stream configured for use during a wash cycle of the point of use.

17. The method of claim 15, wherein at least of the one or more storage tanks comprises a rinse cycle storage tank positioned to receive and store one of the wastewater stream or the treated wastewater stream configured for use during a rinse cycle of the point of use.

18. The method of claim 11, wherein the monitoring sensor comprises one or more light-emitting diodes and one or more photodiodes positioned on opposite sides of a wastewater sample.

19. The method of claim 11, wherein the monitoring system comprises one or more light-emitting diodes configured to emit light through a wastewater sample and a camera configured to produce images of the illuminated wastewater sample.

20. The method of claim 11, wherein the solid filtration module is self-cleaning.
